(19) United States
(12) Patent Application Publication
(10) Pub. No.: US 2026/0338231 A1
(43) Pub. Date: Oct. 29, 2026

(54) WHEEL END HUB LUBRICANT MANAGEMENT

(71) Applicant: FORD GLOBAL TECHNOLOGIES, LLC, Dearborn, MI (US)

(72) Inventors: Emily Suchoski, Shelby Twp, MI (US); Brian James Andonian, Plymouth, MI (US); Brian James Line, Shelby Township, MI (US); Nikolaus Jost, Grosse Pointe, MI (US)

(21) Appl. No.: 19/190,090

(22) Filed: Apr. 25, 2025

(51) Int. Cl. F16C 33/66

(52) U.S. Cl. CPC F16C 33/6629; F16C 33/6622; F16C 2326/02

(57) ABSTRACT

An automotive sub-assembly includes a wheel end hub defining a hub cavity and incorporating inner and outer bearings. In one embodiment, a rifled sleeve is disposed within the hub cavity, contacting the inner and outer bearings. In another embodiment, a fluted sleeve is similarly positioned within the hub cavity. A method of assembling the wheel end hub involves providing a hub with a rifled sleeve between the inner and outer bearings and inserting an axle tube spindle having a protruding spiral bead into the hub.

### TECHNICAL FIELD

The present technology is directed towards a wheel end hub assembly for a vehicle and lubricating the bearings therein.

### BACKGROUND

A wheel end hub of a vehicle, in part, provides a cavity to house various components needed to support a vehicle's axle, such as bearings. The bearings may require lubrication.

### SUMMARY

A wheel end hub assembly, in one example, includes a hub cavity housing inner and outer bearings, along with a rifled sleeve positioned between them. The wheel end hub defines inner and outer shoulders that provide structural support for the rifled sleeve. For sealing and positioning, flow-on gaskets and O-rings are arranged between the sleeve and each shoulder. The rifled sleeve features exterior protruding ridges at both ends, which engage with the shoulders to restrict axial movement and promote correct axial placement within the hub. Additionally, one of the bearings may contribute to limiting sleeve movement.

In another example, a wheel end hub assembly includes a hub body with an interior surface defining first and second bearing seats that house corresponding first and second bearings. Positioned between these bearings is a sleeve with a fluted interior surface, where the flutes taper in both width and depth along the axial direction of the sleeve. The hub body also includes first and second shoulders that provide structural support for the sleeve. For axial positioning, the sleeve may incorporate an exterior annular bead that interacts with one of the shoulders, or alternatively, one of the bearings may cooperate with the sleeve's end to achieve the install depth within the hub body.

A method of assembling a wheel end hub, in one example, involves first positioning a fluted or rifled sleeve between the inner and outer bearings of the hub. A hollow spindle, which features an exterior spiral bead, is then inserted into the sleeve so that it is supported by the bearings. This configuration creates a channel between the interior of the sleeve and the exterior surface of the spindle. Lubricant is applied to either the inner or outer bearing, and it is directed to flow along this channel. To facilitate distribution of the lubricant, the method may further include tilting the hub to use gravity or spinning the spindle, where the spiral bead actively drives the lubricant through the channel.

### BRIEF DESCRIPTION OF THE DRAWINGS

FIG. 1 is a cross-sectional view of a wheel end hub assembly including a rifled sleeve.

FIG. 2 is a cross-sectional view of a wheel end hub assembly including O-rings.

FIG. 3 is a cross-sectional view of a wheel end hub assembly including a fluted sleeve.

FIG. 4 is a cross-sectional view of a step in assembling a wheel end hub assembly.

FIG. 5 is a flow chart of a method of assembling a wheel end hub assembly.

### DETAILED DESCRIPTION

Detailed embodiments are disclosed herein. These embodiments are merely examples and may be embodied in various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

To pack bearings within a wheel hub with grease, the wheel hub may need to be tilted for a period of time to allow the grease to infiltrate the bearings. The present technology incorporates, among other things, a sleeve, along with sealing agents, such as O-rings or flow-on gaskets, at opposing ends of the sleeve to seal a recess within the hub. The sleeve, along with the sealing agents, may affect the volume of grease needed to pack the bearings by preventing the grease from filling the hub recess.

The interior surface of the sleeve may have grease flow-promoting features. During assembly, these features may cooperate with a temporarily installed spindle to affect the movement of grease through the hub and pack the bearings. Once the wheel hub is fully assembled with the sleeve, the assembly may still weigh less than 25 pounds, eliminating the requirement for lift assist usage at the assembly plant. The sleeve may be injection molded and made of a material that resists degradation from mechanical stress, heat, or chemicals in the grease.

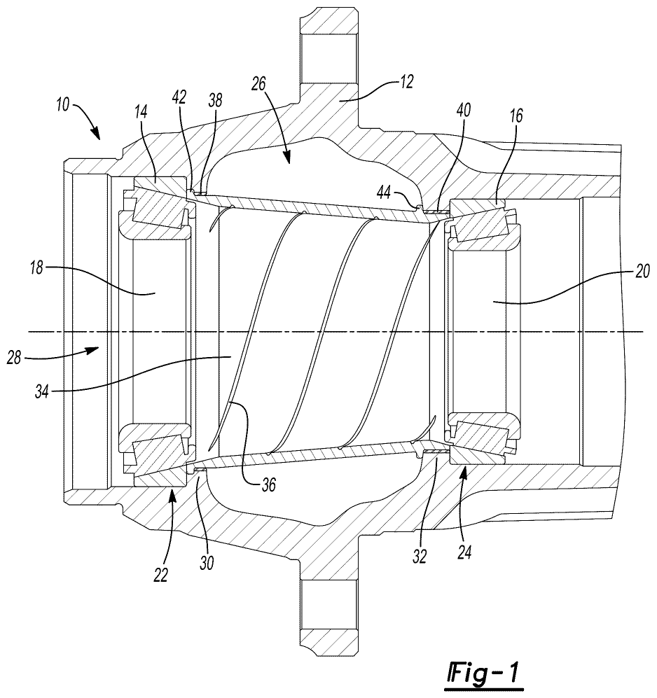

With reference to FIG. 1, a cross-sectional view of an example wheel end hub assembly 10 is shown. The wheel end hub assembly 10 includes a hub body 12, an inner bearing cup 14, an outer bearing cup 16, an inner bearing 18, and an outer bearing 20. The hub body 12 is a cavity with open ends and houses the inner and outer bearing cups 14, 16, and the inner and outer bearings 18, 20. The hub body 12 may be a cast material and may include exterior features that connect to a vehicle's suspension system such that portions of the vehicle are suspended above the wheel end hub assembly 10. In operation, an axle of a vehicle may extend through the wheel end hub assembly 10 through the open ends of the hub body 12 and be supported by the inner and outer bearings 18, 20. The inner and outer bearings 18, 20 may vary in size, for example, the inner bearing 18 may have a larger diameter than the outer bearing 20.

The inner and outer bearing cups 14, 16 each provide a surface that supports the inner and outer bearings 18, 20, respectively. Each cup cooperates with its corresponding bearing to allow the bearings to rotate freely. Although FIG. 1 depicts a bearing cup and its corresponding bearing as separate components, those skilled in the art will understand that once assembled, they function integrally and are often referred to simply as a bearing.

An interior surface of the hub body 12 defines an inner bearing seat 22, an outer bearing seat 24, and a hub recess 26. The inner and outer bearing seats 22, 24 are cylindrical bores each terminating with an annular shoulder. The inner bearing seat 22 and outer bearing seat 24 each extend through portions of the hub body 12 and are sized to receive the inner bearing cup 14 and outer bearing cup 16, respectively. The inner and outer bearing seats 22, 24 are each concentric with an axis 28. The bore defining the inner bearing seat 22 may be larger or smaller than the bore defining the outer bearing seat 24, depending on the size of the bearing cup and/or bearing to be disposed therein. The inner bearing seat 22 and the outer bearing seat 24 each partially define an inner shoulder 30 and an outer shoulder 32, respectively. The inner and outer shoulders 30, 32 are annular projections, extending radially inward, at the end of the bores defining the inner and outer bearing seats 22, 24. When the wheel end hub assembly 10 is assembled, the inner and outer shoulders 30, 32 each provide a positive axial stop for the inner and outer bearing cups 14, 16 and/or the inner and outer bearings 18, 20. The hub recess 26 is an internal recess defined by the internal surface of the hub body 12 between the inner and outer shoulders 30, 32. The hub recess 26 may extend radially beyond the outside diameter defining the inner and outer bearing seats 22, 24, relative to the axis 28.

The wheel end hub assembly 10 includes a sleeve 34 positioned inside the hub body 12 such that the sleeve 34 is positioned between the inner and outer bearings 18, 20, and supported by the inner and outer shoulders 30, 32. The sleeve 34 may have a conical profile depending on the size of the inner and outer shoulders 30, 32. The sleeve 34 may be made from materials such as metal, alloy, or plastic, among others. In some embodiments, the sleeve 34 comprises Nylon. The sleeve 34 is substantially tube shaped, with an interior surface defined by a bore extending through it. Upon installation within the wheel end hub assembly 10, the bore of the sleeve 34 will align concentrically with the axis 28.

In some embodiments, the interior surface of the sleeve 34 may include rifling. The rifling may be defined by a rifling groove 36. The rifling groove 36 is a helical or spiral groove recessed into the interior surface of the sleeve 34. The rifling groove 36 may extend between the sleeve's opposing ends, and its depth into the interior surface of the sleeve 34 may vary. For example, the depth of the rifling groove 36 may taper axially along the sleeve 34. While FIG. 1 depicts a single rifling groove, the sleeve 34 may include more than one rifling groove. Additionally, although FIG. 1 illustrates that the rifling groove 36 is recessed into the interior surface of the sleeve 34, in other embodiments, the rifling may protrude outwardly instead. In such cases, the rifling may be better described as threading or helical knurling. During assembly, the rifling groove 36 may facilitate the flow of a lubricant through the wheel end hub assembly 10, between the inner and outer bearings 18, 20. Other flow promoting features are also possible, such as ribs, channels, or fluting.

To seal the hub recess 26, the wheel end hub assembly 10, in some embodiments, may include an inner flow-on gasket 38 and an outer flow-on gasket 40. A flow on gasket may be applied as a band around an outer edge of the sleeve 34 that is in contact with a shoulder of the hub body 12. The inner flow on gasket 38, together with an outer edge of the sleeve 34 and the inner shoulder 30, form a seal. Similarly, the outer flow on gasket 40, together with another outer edge of the sleeve 34 and the outer shoulder 32, form a seal. These seals, along with the exterior surface of the sleeve 34 and the interior surface of the hub body 12 between the inner and outer shoulders 30,32, cooperate to seal the hub recess 26. The flow on gaskets 38, 40 may be any suitable gasket making material and may be applied as a liquid that then cures into a solid to form an appropriate seal.

The sleeve 34 may include axial positioning structures. For example, the exterior surface of the sleeve 34 includes an inner protruding ridge 42 and an outer protruding ridge 44 at opposing ends, each extending outwardly from the exterior surface of the sleeve 34. The inner and outer protruding ridges 42, 44 each engage with surfaces of the inner and outer shoulders 30, 32, respectively, to restrict axial movement of the sleeve 34 and to secure the sleeve 34 at a predetermined depth within the hub. In this sense, the protruding ridges 42 and 44 may provide press-fit structures such that the sleeve 34 may be press-fitted into the wheel-end hub assembly 10 at an appropriate axial depth. Further, the inner and outer bearing cups 14, 16 and/or inner and outer bearings 18, 20 may contact the sleeve 34 at opposing ends to further restrict axial movement of the sleeve 34.

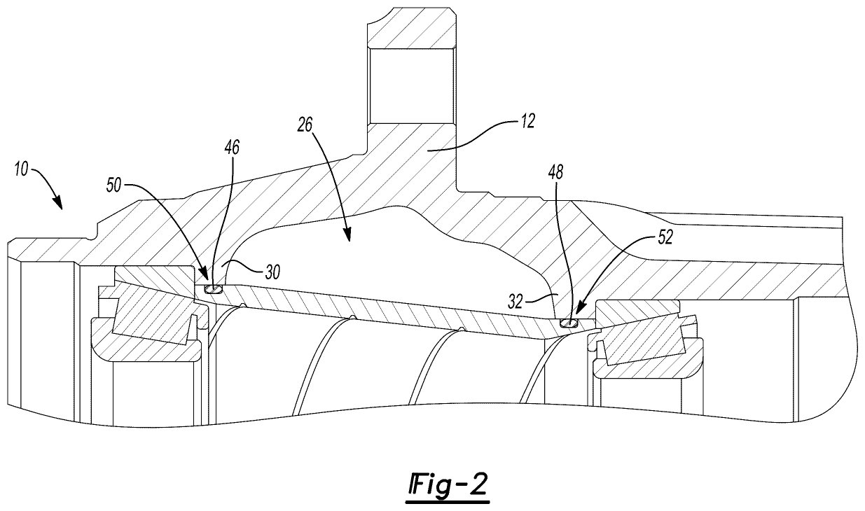

With reference to FIG. 2, the wheel-end hub assembly 10, in some embodiments, may include an inner O-ring 46 and an outer O-ring 48. Further, in some embodiments of the sleeve 34, the sleeve 34 may have an inner O-ring groove 50 and an outer O-ring groove 52 embedded into the exterior surface of the sleeve 34 at opposite ends. During assembly, the inner and outer O-rings 46, 48 are disposed into the inner and outer O-ring grooves 50, 52, respectively. Once assembled, the inner O-ring 46, together with the inner O-ring groove 50 and the inner shoulder 30, cooperate to form a seal. Similarly, the outer O-ring 48, together with the outer O-ring groove 52 and outer shoulder 32, cooperate to form a seal. These seals, along with the exterior surface of the sleeve 34 and the interior surface of the hub body 12 between the inner and outer shoulders 30 and 32, cooperate to seal the hub recess 26.

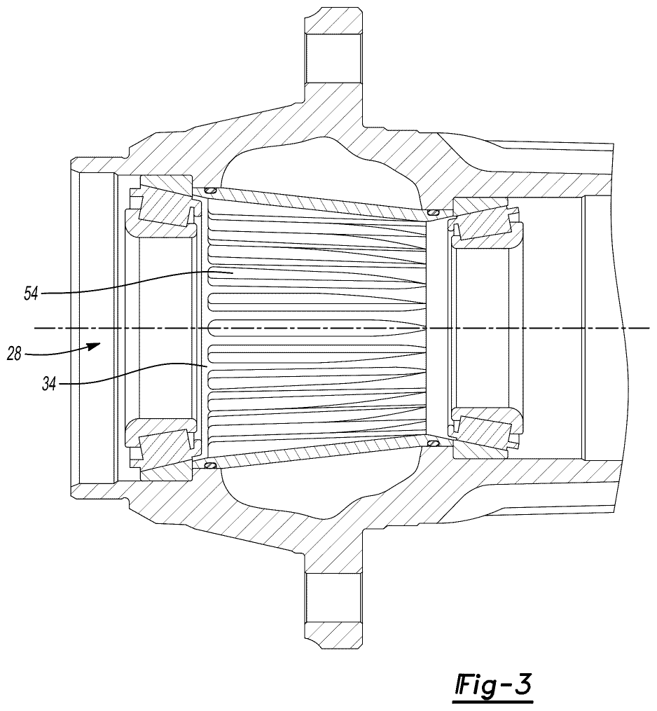

With reference to FIG. 3, in some embodiments of the sleeve 34, the interior surface of the sleeve 34 may include fluting. The fluting may be defined by a plurality of recessed axial grooves 54. The axial grooves 54 extend along the interior surface of sleeve 34, running parallel with the axis 28. The depth of the axial grooves 54 may taper along the axial direction. For example, at one end of the sleeve 34, the grooves 54 may extend deeper into the sleeve 34 compared to an opposite end. Additionally, the width of the axial grooves 54 may taper along the axial direction, becoming narrower from one end of the sleeve 34 to the other. Although FIG. 3 depicts the axial grooves 54 as being recessed into the interior surface of the sleeve 34, in other embodiments, the grooves may protrude outwardly instead. In such cases, the interior surface of the sleeve 34 may be more accurately described as being splined.

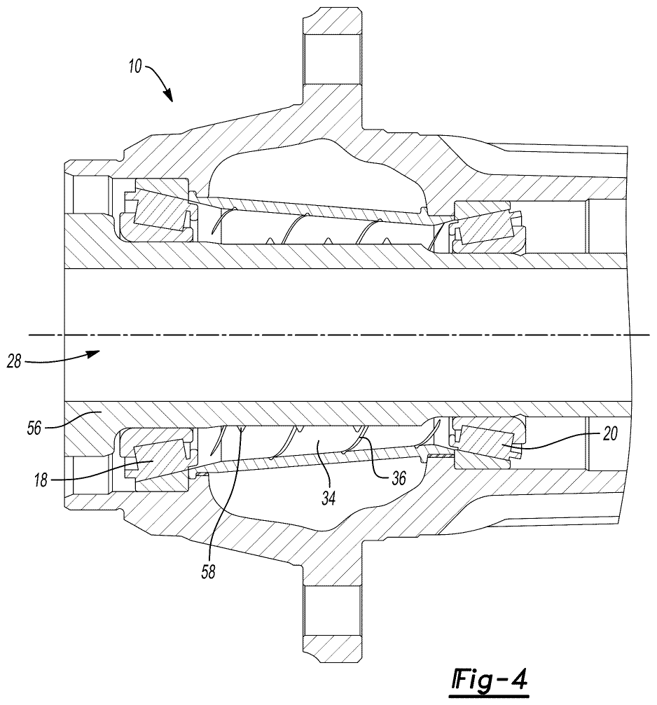

FIG. 4 illustrates a step in assembling a wheel end hub. At this step, a lubricant spindle 56 is installed into the wheel end hub assembly 10. The lubricant spindle 56 is a generally hollow cylindrical body, and when installed into the wheel end hub, extends through and between the inner and outer bearings 18, 20. Although FIG. 4 illustrates the lubricant spindle 56 as hollow, it is not necessarily required to be. The lubricant spindle 56 is dimensioned such that, when installed in the wheel end hub assembly 10, portions of its exterior surface are supported by the inner and outer bearings 18, 20. The lubricant spindle 56 may include a spiral rib 58 protruding from its exterior cylindrical surface, extending along a portion of the spindle's length. When installed, the spiral rib 58 extends between the inner and outer bearings 18, 20. The spiral rib 58 may be complementary to the rifled groove 36. Although FIG. 4 depicts the lubricant spindle 56 with a single spiral rib 58, alternative embodiments may include multiple spiral ribs.

During assembly of the wheel end hub 10, the spiral rib 58 of the lubricant spindle 56 may cooperate with the internal surface of the sleeve 34 to promote a flow of applied lubricant between the inner and outer bearings 18, 20. For example, in embodiments where the sleeve 34 has the rifled groove 36, the spiral rib 58 and the rifled groove 36 form a helically interwoven channel that extends between the inner and outer bearings 18, 20. The depth and pitch of the rifling and rib influence the cross-sectional profile of the channel, creating a repeatedly expanding and contracting channel that promotes a circular and/or turbulent flow of the lubricant. Similarly, in embodiments where the sleeve 34 has a fluted interior surface, as shown in FIG. 3, the lubricant spindle's spiral rib may cooperate with the fluting to promote the flow of lubricant between the inner and outer bearings 18, 20.

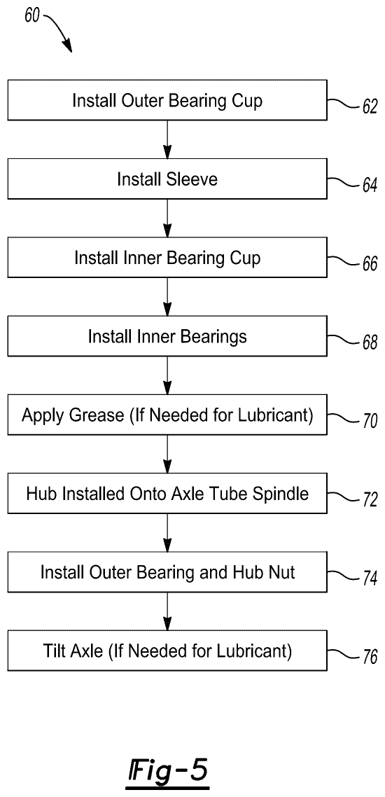

With reference to FIG. 5, a method 60 for assembling a wheel end hub is shown. Method 60 incorporates the elements shown in FIG. 1-FIG. 4. The method 60 may begin at step 62 where the outer bearing cup 16 is installed into the outer bearing seat 24 inside of the hub body 12. At step 64, the sleeve 34 is installed such that the sleeve 34 is supported by the inner and outer shoulders 30, 32 within the hub body 12. The void between the sleeve 34 and the interior surface of the hub body 12, between the inner and outer shoulders 30, 32, defines the hub recess 26. In embodiments where the inner and outer flow-on gaskets 38, 40 are used to seal the hub recess 26, the inner and outer flow-on gaskets 38, 40 are applied as bands around the exterior surface of the sleeve at opposing edges before the sleeve 34 is installed. In embodiments where the inner and outer O-rings 46, 48 are used to seal the hub recess 26, the inner and outer O-rings 46, 48 are installed into the inner and outer O-ring grooves 50, 52, respectively, at opposing ends of the sleeve 34 before the sleeve 34 is installed. The sleeve 34 and the O-rings and/or flow on gaskets seal the hub recess 26 where the sleeve 34 contacts the inner and outer shoulders 30, 32. The exterior surface of the sleeve 34 may include the protruding ridges 42, 44, which cooperate with the inner and outer shoulders 30, 32 such that the sleeve 34 is installed at an appropriate depth within the hub body 12. An interior surface of the sleeve 34 may include lubricant flow promoting features such as rifling or fluting, as shown in FIG. 1-FIG. 4. At step 66, the inner bearing cup 14 is installed into the inner bearing seat 22. The inner bearing cup 14 may contact the sleeve 34. At step 68, the inner bearing 18 is installed into the inner bearing cup 14 such that the elements of the inner bearing 16 contact the bearing cup 14. Portions of the inner bearing 18 may also contact the sleeve 34.

At step 70, grease is applied if needed for lubricant. At step 72, the hub body 12 is installed onto the axle tube spindle. At step 74, the outer bearing 20 and hub nut are installed. The axle, at operation 76, may then be tilted to a specified angle to induce and facilitate gravity-assisted flow of the grease through a channel defined between the lubricant spindle and the sleeve 34 to the other bearing. The sleeve 34, sealed to the inner and outer shoulders 30, 32, prevents the lubricant from filling the hub recess 26. Additionally, the rifling or fluting of the sleeve 34, depending on which embodiment of the sleeve 34 is used, may cooperate with the protruding spiral rib 58 on the lubricant spindle 56 to affect or promote the flow of lubricant between the inner and outer bearings 18, 20. The lubricant spindle 56 may also be spun in place, with the spiral rib 58 directing the lubricant axially into a bearing.

With respect to method 60, it should be understood that the sequence of assembly described herein is merely exemplary, and the steps need not occur in the order presented. For example, in certain embodiments of the method 60, the steps 62 and 66 may be performed in reverse order, such that the inner bearing cup is installed first. The specific sequence of installing the inner or outer bearing cup may depend on various factors, including the conical shape of the sleeve, the relative sizes of the inner and outer shoulders, and the dimensions of the bearing cups. For instance, if the sleeve has a conical profile, the conical taper of the sleeve may necessitate installing the inner bearing cup first to ensure proper alignment and accommodation within the hub body.

1. An automotive sub-assembly comprising,
a wheel end hub defining a hub cavity and including inner and outer bearings, and a rifled sleeve disposed in the hub cavity between the inner and outer bearings and defining an interior bore, wherein the rifled sleeve includes a helical groove extending between opposing ends of the rifled sleeve, wherein the interior bore is configured to receive a spindle having an exterior spiral bead extending between the inner and outer bearings, and wherein the helical groove and the exterior spiral bead cooperate to define a channel configured to direct lubricant between the inner and outer bearings.

2. The automotive sub-assembly of claim 1, wherein the wheel end hub further defines inner and outer shoulders and wherein the rifled sleeve is supported by the inner and outer shoulders.

3. The automotive sub-assembly of claim 2 further comprising a plurality of flow-on-gaskets, each disposed between the rifled sleeve and one of the inner and outer shoulders.

4. The automotive sub-assembly of claim 2 further comprising a plurality of O-rings, each disposed between the rifled sleeve and one of the inner and outer shoulders.

5. The automotive sub-assembly of claim 1, wherein the rifled sleeve defines a first and second exterior protruding ridge at opposing ends of the sleeve.

6. The automotive sub-assembly of claim 5, wherein the wheel end hub further defines an inner and outer shoulder and wherein each of the first and second exterior protruding ridges is configured to cooperate with one of the inner and outer shoulders to restrict axial movement of the rifled sleeve.

7. The automotive sub-assembly of claim 6, wherein one of the inner and outer bearings is configured to further restrict axial movement of the rifled sleeve.

8. The automotive sub-assembly of claim 5, wherein the wheel end hub further defines inner and outer shoulders and wherein each of the first and second exterior protruding ridges is configured to cooperate with one of the inner and outer shoulders to position the rifled sleeve at a pre-defined axial install depth within the wheel end hub.

9. The automotive sub-assembly of claim 1, wherein the helical groove and the exterior spiral bead define a helically interwoven channel extending between the inner and outer bearings.

10. A wheel end hub assembly comprising:
a hub body having an interior surface defining first and second bearing seats;
first and second bearings, each disposed in one of the first and second bearing seats; and
a sleeve having a fluted interior surface disposed between the first and second bearings, wherein flutes of the fluted interior surface taper in width along an axial direction of the sleeve.

11. (canceled)

12. The wheel end hub assembly of claim 10, wherein the flutes taper in depth along an axial direction of the sleeve.

13. The wheel end hub assembly of claim 10, wherein the interior surface of the hub body further defines first and second shoulders configured to support the sleeve.

14. The wheel end hub assembly of claim 13, wherein the sleeve further includes an exterior annular bead configured to cooperate with one of the first or second shoulders to position the sleeve at a predetermined install-depth within the hub body.

15. The wheel end hub assembly of claim 10, wherein one of the first and second bearings is configured to cooperate with an end of the sleeve to position the sleeve at a predetermined install depth within the hub body.

16. A method of assembling a wheel end hub, comprising:
inserting a fluted or rifled sleeve between inner and outer bearings of the wheel end hub;
inserting a hollow spindle, having an exterior surface defining an exterior spiral bead, into the sleeve such that the hollow spindle is supported by the inner and outer bearings, and an interior of the sleeve and the exterior surface of the hollow spindle including the exterior spiral bead define a channel therebetween; and
applying a lubricant to one of the inner or outer bearings such that the lubricant flows along the channel.

17. The method of claim 16 further comprising tilting the wheel end hub such that gravity promotes movement of the lubricant through the channel.

18. The method of claim 16 further comprising spinning the hollow spindle such that the exterior spiral bead promotes movement of the lubricant through the channel.

19. The automotive sub-assembly of claim 1, wherein the helical groove and the exterior spiral bead define a channel having alternating expansions and contractions along an axial length of the rifled sleeve.

20. The automotive sub-assembly of claim 1, wherein the helical groove tapers in depth along an axial direction of the rifled sleeve.
